(19) United States
(12) Patent Application Publication
(10) Pub. No.: US 2018/0023434 A1
(43) Pub. Date: Jan. 25, 2018

(54) METHOD OF MANUFACTURING CATALYZED PARTICULATE FILTER

(71) Applicant: Hyundai Motor Company, Seoul (KR)

(72) Inventors: ChangHo JUNG, Osan-si (KR); Pyung Soon KIM, Suwon-si (KR)

(73) Assignee: Hyundai Motor Company, Seoul (KR)

(21) Appl. No.: 15/361,133

(22) Filed: Nov. 25, 2016

(30) Foreign Application Priority Data
Jul. 25, 2016 (KR) 10-2016-0094296

(51) Int. Cl. F01N 3/035; B01J 37/02; F01N 3/28; F01N 3/022; F01N 3/08; F01N 3/20; B01D 53/94; B01J 35/04

(52) U.S. Cl. CPC F01N 3/035; B01D 53/9472; B01J 37/024; B01J 37/0236; B01J 35/04; F01N 3/0222; F01N 3/0821; F01N 3/0842; F01N 3/2066; F01N 3/2882; B01D 2255/903; B01D 2255/9155; B01D 2255/9202

(57) ABSTRACT

A method of manufacturing a catalyzed particulate filter may include: preparing a bare particulate filter; injecting a first catalyst slurry into at least one inlet channel or at least one outlet channel; discharging a portion of the first catalyst slurry by blowing gas into the at least one outlet channel or the at least one inlet channel or drawing the gas from the at least one inlet channel or the at least one outlet channel; injecting a second catalyst slurry into the at least one outlet channel or the at least one inlet channel; discharging a portion of the second catalyst slurry by blowing gas into the at least one inlet channel or the at least one outlet channel or drawing the gas from the at least one outlet channel or the at least one inlet channel; and drying/calcining the particulate filter from which the portion of the first catalyst slurry and the portion of the second catalyst slurry are discharged.

### CROSS-REFERENCE TO RELATED APPLICATION

The present application claims priority to and the benefit of Korean Patent Application No. 10-2016-0094296 filed on Jul. 25, 2016, the entire contents of which are incorporated herein by reference.

### BACKGROUND OF THE INVENTION

### Field of the Invention

The present invention relates to a method of manufacturing a catalyzed particulate filter. More particularly, the present invention relates to a method of manufacturing a catalyzed particulate filter including at least one porous wall defining a boundary between at least one inlet channel and at least one outlet channel, a first support located within at least one among the at least one inlet channel, and a second support located within at least one among the at least one outlet channel, the method being related to effectively coating a catalyst on the at least one wall and the first and the second supports.

### Description of Related Art

An exhaust gas from internal combustion engines such as diesel engines or a variety of combustion equipment contains particulate matter (PM). Such PMs can cause environmental pollution when emitted into the atmosphere. For this reason, gas exhaust systems are equipped with a particulate filter for capturing PM.

The particulate filter may be categorized as a flow-through particulate filter or a wall-flow particulate filter depending on a flow of fluid.

In the flow-through particulate filter, a fluid flowing into a channel flows only within this channel without moving to another channel. This helps minimize an increase in back pressure, but necessitates a means for capturing particulate matter in the fluid and may result in low filter performance.

In the wall-flow particulate filter, a fluid flowing into a channel moves to an adjacent channel and is then discharged from the particulate filter through the adjacent channel. That is, a fluid flowing into an inlet channel moves to an outlet channel through a porous wall and is then discharged from the particulate filter through the outlet channel. When a fluid passes through the porous wall, particulate matter in the fluid is captured without passing through the porous wall. The wall-flow particulate filter is effective at removing particulate matter, although it may increase the back pressure to some extent. Hence, wall-flow particulate filters are primarily used.

A vehicle is equipped with at least one catalytic converter, along with a particulate filter. The catalytic converter is designed to remove carbon monoxide (CO), hydrocarbon (HC), and nitrogen oxide (NOx).

The catalytic converter may be physically separated from the particulate filter, or combined with the particulate filter by coating a catalyst in the particulate filter. The particulate filter coated with a catalyst may be called a catalyzed particulate filter (CPF).

In the CPF, the catalyst is coated on the porous wall that separates the inlet channel and the outlet channel from each other, and the fluid passes through the porous wall and contacts with the catalyst coating. There is a pressure difference between the inlet channel and outlet channel separated by the porous wall. This allows the fluid to pass fast through the porous wall. Accordingly, the contact time between the catalyst and the fluid is short, which makes it hard for a catalytic reaction to occur efficiently.

Also, a thick catalyst coating on the porous wall allows the catalyst to block the micropores on the wall, and this may disturb the flow of the fluid from the inlet channel to the outlet channel. Accordingly, the back pressure increases. To minimize the increase in back pressure, a catalyst is thinly coated on the walls in the CPF. Thus, an amount of catalyst coating in the CPF may be insufficient for the catalytic reaction to occur efficiently.

To overcome this problem, the surface area of walls to be coated with the catalyst may be increased by increasing the number (density) of inlet channels and outlet channels (hereinafter, collectively referred to as ‘cells’). However, the increase in cell density in the limited space reduces the wall thickness. The reduction in wall thickness may deteriorate the filter performance. Therefore, the cell density should not be increased to more than the density limit.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of manufacturing a catalyzed particulate filter having advantages of minimizing an increase in back pressure and increasing catalyst loading.

Another exemplary embodiment various aspects of the present invention are directed to providing a method of manufacturing a catalyzed particulate filter having advantages of increasing entire catalyst loading coated in the particulate filter but minimizing catalyst loading coated on a porous wall by disposing first and second supports on which much catalyst is coated in inlet channels and outlet channels.

Various aspects of the present invention are directed to providing a method of manufacturing a catalyzed particulate filter having advantages of coating different catalysts on inlet channels and outlet channels in the catalyzed particulate filter including first and second supports.

A method of manufacturing a catalyzed particulate filter according to an exemplary embodiment of the present invention may include: preparing a bare particulate filter including at least one inlet channel which may have a first end being open and a second end being blocked, at least one outlet channel which may have a first end being blocked and a second end being open and which is positioned alternately with the at least one inlet channel, at least one porous wall which defines a boundary between adjacent inlet and outlet channels, at least one first support which is located within at least one among the at least one inlet channel, and at least one second support which is located within at least one among the at least one outlet channel; injecting a first catalyst slurry into the at least one inlet channel or the at least one outlet channel; discharging a portion of the first catalyst slurry by blowing gas into the at least one outlet channel or the at least one inlet channel or drawing the gas from the at least one inlet channel or the at least one outlet channel; injecting a second catalyst slurry into the at least one outlet channel or the at least one inlet channel; discharging a portion of the second catalyst slurry by blowing gas into the at least one inlet channel or the at least one outlet channel or drawing the gas from the at least one outlet channel or the at least one inlet channel; and drying/calcining the particulate filter from which the portion of the first catalyst slurry and the portion of the second catalyst slurry are discharged.

The at least one inlet channel, the at least one outlet channel, the at least one porous wall, and the at least one first and second supports may extend in a same direction.

The first catalyst slurry may be coated on an inside surface of the at least one inlet channel and the at least one first support or on an inside surface of the at least one outlet channel and the at least one second support, and the second catalyst slurry may be coated on the inside surface of the at least one outlet channel and the at least one second support or the inside surface of the at least one inlet channel and the at least one first support.

An amount of the first catalyst slurry removed from the inside surface of the at least one inlet channel or the at least one outlet channel may be larger than that of the first catalyst slurry removed from the first support or the second support in the discharging a portion of the first catalyst slurry.

An amount of the second catalyst slurry removed from the inside surface of the at least one outlet channel or the at least one inlet channel may be larger than that of the second catalyst slurry removed from the second support or the first support in the discharging a portion of the second catalyst slurry.

An amount of a catalyst coated on the inside surface of the inlet channels may be controlled by adjusting a pressure of the gas which is blown into the outlet channels or which is drawn from the inlet channels.

An amount of a catalyst coated on the inside surface of the outlet channels may be controlled by adjusting a pressure of the gas which is blown into the inlet channels or which is drawn from the outlet channels.

In one aspect, the first and the second supports may include a same material as the porous walls.

In another aspect, the first and the second support may include a same material which is different from a material of the porous walls.

Viscosities of the first and the second catalyst slurries may be larger than or equal to 200 cpsi.

The viscosities of the first and the second catalyst slurries may be controlled according to contents of solid particles of the first and the second catalyst slurries, pH of the first and the second catalyst slurries, and particle sizes of the solid particles of the first and the second catalyst slurries.

Average particle sizes of the first and the second catalyst solid particles of the first and the second catalyst slurries may be controlled to be larger than an average pore size of the porous walls.

In one aspect, the first catalyst slurry and the second catalyst slurry may have the same ingredients.

In another aspect, the first catalyst slurry and the second catalyst slurry may have different ingredients from each other.

The first catalyst slurry may be a lean NOx trap (LNT) catalyst slurry and the second catalyst slurry may be a selective catalytic reduction (SCR) catalyst slurry.

As described above, increase in back pressure may be minimized and entire catalyst loading may be increase by disposing a first support within at least one among at least one inlet channel, disposing a second support within at least one among at least one outlet channel, and coating much catalyst on the first and second supports to reduce catalyst loading on a porous wall.

In addition, sufficient filter performance and catalyst performance can be achieved since larger catalyst loading and a larger contact area (time) between a fluid and the catalyst are provided while keeping the wall thickness.

Further, degree of freedom of catalysts coated in a limited space may be increased by coating different types of catalysts on the first support and the second support.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a perspective view of a catalyzed particulate filter according to an exemplary embodiment of the present invention.

FIG. 2 is a cross-sectional view of the catalyzed particulate filter according to an exemplary embodiment of the present invention.

FIG. 3 is a front view illustrating some of inlet and outlet channels in the catalyzed particulate filter according to an exemplary embodiment of the present invention.

FIG. 4 is a graph illustrating the nitrogen oxide reduction vs. the amount of catalyst coating in a wall-flow particulate filter.

FIG. 5 is a graph illustrating the nitrogen oxide reduction vs. the amount of catalyst coating in a flow-through carrier.

FIG. 6 is a graph illustrating the back pressure vs. the amount of catalyst coating in the wall-flow particulate filter.

FIG. 7 is a graph illustrating the back pressure vs. the amount of catalyst coating in the flow-through media.

FIG. 8 is a graph illustrating the back pressure vs. the cell density in the flow-through media.

FIG. 9 is a graph illustrating the back pressure vs. the cell density in the wall-flow particulate filter.

FIG. 10 is a schematic diagram sequentially illustrating a method of manufacturing a catalyzed particulate filter according to an exemplary embodiment of the present invention.

FIG. 11 is a graph showing a catalyst loading on porous walls according to a viscosity of a catalyst slurry.

FIG. 12 is a graph showing a catalyst loading on porous walls according to an average particle size of a solid particle of a catalyst slurry.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

A catalyzed particulate filter according to an exemplary embodiment of the present invention is configured for use in variety of devices, as well as vehicle, that get energy by burning fossil fuels and emit gases produced in the burning process into the atmosphere. Although this specification illustrates an example of a catalyst particulate filter configured for use in a vehicle, the present invention should not be construed as limited to this example.

The vehicle is equipped with an engine for generating power. The engine converts chemical energy into mechanical energy by the combustion of a fuel-air mixture. The engine is connected to an intake manifold to draw air into a combustion chamber, and connected to an exhaust manifold where an exhaust gas produced during combustion is collected and emitted out. Injectors are mounted at the combustion chamber or intake manifold to spray fuel into the combustion chamber or intake manifold.

The exhaust gas produced from the engine is emitted out of the vehicle via an exhaust system. The exhaust system may include an exhaust pipe and exhaust gas recirculation (EGR) apparatus.

The exhaust pipe is connected to the exhaust manifold to emit the exhaust gas out of the vehicle.

The exhaust gas recirculation apparatus is mounted on the exhaust pipe, and the exhaust gas emitted from the engine pass through the exhaust gas recirculation apparatus. Also, the exhaust gas recirculation apparatus is connected to the intake manifold and mixes some of the exhaust gas with air to control the combustion temperature. The combustion temperature may be regulated by controlling ON/OFF of an exhaust gas recirculation (EGR) valve in the exhaust gas recirculation apparatus. That is, the amount of exhaust gases supplied to the intake manifold is adjusted by controlling the ON/OFF of the EGR valve.

The exhaust system may further include a particulate filter that is mounted on the exhaust pipe and captures particulate matter in the exhaust gas. The particulate filter may be a catalyzed particulate filter according to an exemplary embodiment of the present invention that removes harmful substances as well as particulate matter in exhaust gases.

Hereinafter, a catalyzed particulate filter according to an exemplary embodiment of the present invention will be described in detail with reference to the accompanying drawings.

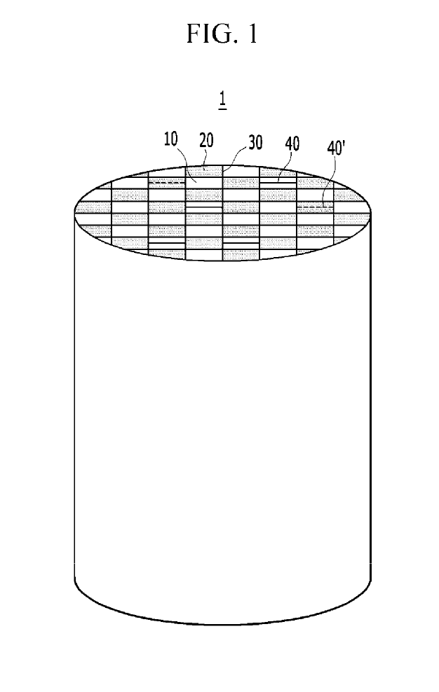

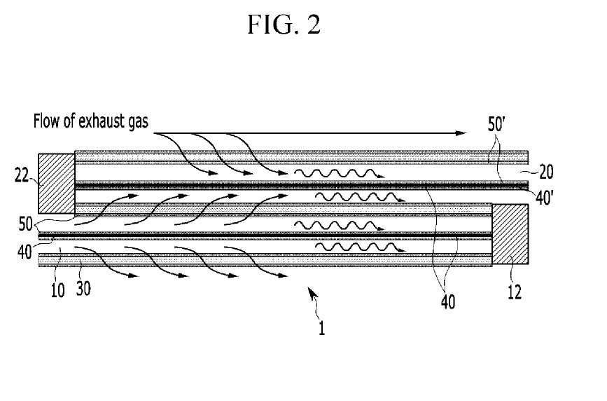

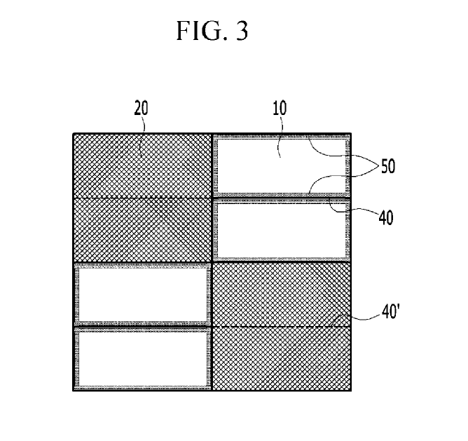

FIG. 1 is a perspective view of a catalyzed particulate filter according to an exemplary embodiment of the present invention; FIG. 2 is a cross-sectional view of the catalyzed particulate filter according to an exemplary embodiment of the present invention; FIG. 3 is a front view illustrating some of inlet and outlet channels in the catalyzed particulate filter according to an exemplary embodiment of the present invention.

As illustrated in FIG. 1, a catalyzed particulate filter according to an exemplary embodiment of the present invention includes at least one inlet channel 10 and at least one outlet channel 20 within a housing. The at least one inlet channel 10 and the at least one outlet channel 20 are separated from each other by walls 30. In addition, at least one first support 40 is located within at least one among the at least one inlet channel 10, and at least one second support 40′ is located within at least one among the at least one outlet channel 20.

In this specification, the inlet channel 10 and the outlet channel 20 may be collectively referred to as ‘cells’. Although, in this specification, the housing has a cylindrical shape and the cells have a rectangular shape, the housing and the cells are not limited to such shapes. Although, in this specification, the first support 40 is located within the inlet channel 10 and the second support 40′ is located within the outlet channel 20, the first support 40 and the second support 40′ are not limited to such locations. That is, the second support 40′ may be located within the inlet channel 10 and the first support 40 may be located within the outlet channel 20. For ease of explanation, it will hereinafter be exemplified that the first support 40 is located within the inlet channel 10 and the second support 40′ is located within the outlet channel 20.

Referring to FIG. 2 and FIG. 3, the inlet channel 10 extends along the flow of the exhaust gas. The front end of the inlet channel 10 is open so that the exhaust gas is introduced into the particulate filter 1 through the inlet channel 10. The rear end of the inlet channel 10 is blocked by a first plug 12. Thus, the exhaust gas in the particulate filter 1 does not flow out of the particulate filter 1 through the inlet channel 10.

The outlet channel 20 extends along the flow of the exhaust gas, and may be placed parallel to the inlet channel 10. At least one inlet channel 10 is located around the outlet channel 20.

For example, when the cells have a rectangular shape, each outlet channel 20 is surrounded by walls 30 on four sides. At least one of the four sides is located between each outlet channel 20 and an adjacent inlet channel 10. When the cells have a rectangular shape, each outlet channel 20 may be surrounded by four adjacent inlet channels 10 and each inlet channel 10 may be surrounded by four adjacent outlet channels 20, but the present invention is not limited thereto.

Since the front end of the outlet channel 20 is blocked by a second plug 22, the exhaust gas does not flow into the particulate filter 1 through the outlet channel 20. The rear end of the outlet channel 20 is open so that the exhaust gas in the particulate filter 1 flows out of the particulate filter 1 through the outlet channel 20.

The wall 30 is placed between adjacent inlet and outlet channels 10 and 20 to define the boundary between them. The wall 30 may be a porous wall 30 with at least one micropore therein. The porous wall 30 allows the adjacent inlet and outlet channels 10 and 20 to fluidically-communicate with each other. Thus, the exhaust gas introduced into the inlet channel 10 may move to the outlet channel 20 through the porous wall 30. Moreover, the porous wall 30 does not cause particulate matter in the exhaust gas to pass therethrough. When the exhaust gas moves from the inlet channel 10 to the outlet channel 20 through the porous wall 30, the particulate matter in the exhaust gases is filtered by the porous wall 30. The porous wall 30 may be made from aluminum titanate, codierite, silicon carbide, etc.

A first catalyst 50 may be coated on the porous walls 30 forming an inside surface of the inlet channel 10

The first catalyst 50 coated on the porous walls 30 forming the inside surface of the inlet channel 10 is not limited to particular ones. In other words, the porous walls 30 forming the inside surface of the inlet channel 10 may be coated with a variety of first catalysts 50 including a lean NOx trap (LNT) catalyst, a three-way catalyst, an oxidation catalyst, a hydrocarbon trap catalyst, a selective catalytic reduction (SCR) catalyst, etc., depending on the design intent.

A second catalyst 50′ may be coated on the porous walls 30 forming an inside surface of the outlet channel 20. The second catalyst 50′ coated on the porous walls 30 forming the inside surface of the outlet channel 20 is not limited to particular ones. In other words, the porous walls 30 forming the inside surface of the outlet channel 20 may be coated with a variety of second catalysts 50′ including a lean NOx trap (LNT) catalyst, a three-way catalyst, an oxidation catalyst, a hydrocarbon trap catalyst, a selective catalytic reduction (SCR) catalyst, etc., depending on the design intent. In addition, the second catalyst 50′ may be the same as or be different from the first catalyst 50. For example, the first catalyst 50 may be the LNT catalyst and the second catalyst 50′ may be the SCR catalyst, but the first and the second catalyst 50 and 50′ may not be limited to such catalysts.

The at least one first support 40 may be located within the at least one among the at least one inlet channel 10 and the at least one second support 40′ may be located within the at least one among the at least one outlet channel 20. It is illustrated in FIG. 1 to FIG. 3 that the first and the second supports 40 and 40′ extend parallel to a direction in which the inlet channel 10 and/or the outlet channel 20 extend, but the extending direction of the first and the second supports 40 and 40′ may not be limited to such one. That is, the first and the second supports 40 and 40′ may extend perpendicular or obliquely to the direction in which the inlet channel 10 and/or the outlet channel 20 extend. In the case that the first and the second supports 40 and 40′ extend perpendicular or obliquely to the direction in which the inlet channel 10 and/or the outlet channel 20 extend, at least one of the two ends of the first and the second supports 40 and 40′ may not contact with the porous wall 30 that separates the cells from one another. In the case that the first and the second supports 40 and 40′ extend parallel to the direction in which the inlet channel 10 and/or the outlet channel 20 extend, the first and the second supports 40 and 40′ may extend over an entire length of the channel 10 or 20 or extend over part of the length of the channel 10 or 20.

The first and the second supports 40 and 40′ are coated with catalysts. The catalysts coated on the first and the second supports 40 and 40′ are not limited to particular ones. In other words, the first and the second supports 40 and 40′ may be coated with a variety of catalysts 40 including a lean NOx trap (LNT) catalyst, a three-way catalyst, an oxidation catalyst, a hydrocarbon trap catalyst, a selective catalytic reduction (SCR) catalyst, etc. depending on the design intention. In addition, the catalysts coated on the first and the second supports 40 and 40′ may be the same as or be different from each other. Furthermore, the catalyst coated on the first support 40 may be the same as or be different from the first catalyst 50, and the catalyst coated on the second support 40′ may be the same as or be different from the second catalyst 50′. In addition, the first catalyst 50 may be coated on the first support 40 and the second catalyst 50′ may be coated on the second support 40′. As mentioned above, the first catalyst 50 may be the same as or be different from the second catalyst 50′. For example, the first catalyst 50 coated on the first support 40 may be the LNT catalyst and the second catalyst 50′ coated on the second support 40′ may be the SCR catalyst. However, the first and the second catalysts 50 and 50′ may not be limited to such ones. Furthermore, different types of catalysts may be coated on both surfaces of each support 40 or 40′.

Meanwhile, the first and the second supports 40 are provided to hold the catalysts 50 and 50′ in place, rather than serving as filters. Thus, the first and the second supports 40 and 40′ are not necessarily made from porous materials. That is, the first and the second supports 40 and 40′ may be made from the same material as the porous wall 30 or a different material. in the case that the first and the second supports 40 and 40′ are made from porous materials, the exhaust gas mostly moves along the first and the second supports 40 and 40′ and the walls 30 without passing through the first and the second supports 40 and 40′, because there is little difference in pressure between the two parts of the channel 10 or 20 separated by the first or the second support 40 or 40′. Also, the first and the second supports 40 do not need to be thick since they are not required to serve as filters. That is, the first and the second supports 40 may be thinner than the wall 30, which minimizes an increase in back pressure. When the first and the second supports 40 are made from porous materials, the catalysts 50 and 50′ are coated on surfaces of the first and the second supports 40 and 40′ and on the micropores in the first and the second supports 40 and 40′. On the contrary, when the first and the second supports 40 and 40′ are made from non-porous materials, the catalysts 50 and 50′ are coated on the surfaces of the first and the second supports 40 and 40′.

As mentioned previously, the first and the second catalysts 50 and 50′ may be coated on the first and the second supports 40 and 40′ and the porous walls 30. In the instant case, amounts of the first and the second catalysts 50 and 50′ coated on the first and the second supports 40 and 40′ may be greater than those coated on the porous walls 30. The first and the second catalysts 50 and 50′ may be thinly coated on the porous walls 30 since the porous walls 30 serves as filters. On the contrary, the first and the second catalysts 50 and 50′ may be thickly coated on the first and the second supports 40 and 40′ since the first and the second supports 40 and 40′ are not required to serve as filters. Accordingly, the amount of catalyst coating in the particulate filter 1 may be increased. Here, the amount of catalyst refers to the amount of catalyst loading per unit length or unit area.

Operation of the catalyzed particulate filter according to the exemplary embodiment of the present invention will be described below.

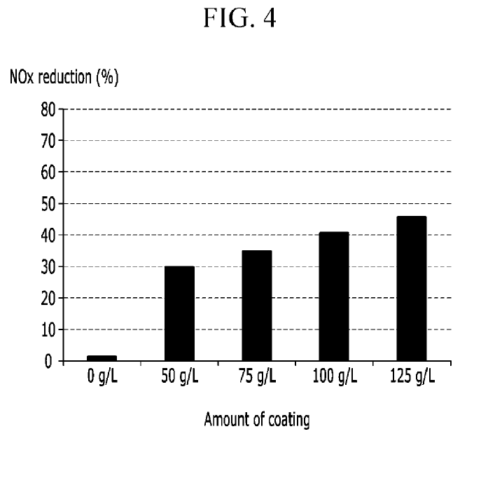

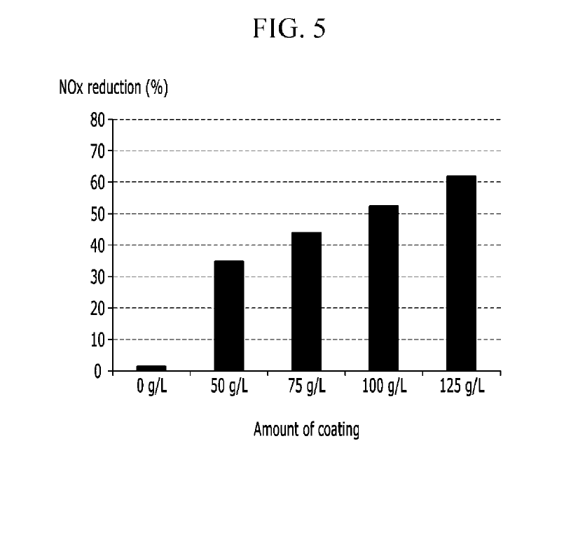

FIG. 4 is a graph illustrating the nitrogen oxide reduction vs. the amount of catalyst coating in a wall-flow particulate filter; and FIG. 5 is a graph illustrating the nitrogen oxide reduction vs. the amount of catalyst coating in a flow-through carrier.

FIG. 4 and FIG. 5 illustrate measurement data obtained by running the same engine in the same mode. The particulate filter used in the test has the same cross-sectional area, volume, and catalyst coating amount as the carrier used in the test, and the number of cells in the particular filter is different from the number of cells in the carrier. The walls in the particulate filter cannot be made thin since they are required to function as filters, which results in a small number of cells. On the contrary, the walls in the carrier can be made thin since they are not required to function as filters, which results in a larger number of cells. A cell density of the particulate filter used in the test is 300 cpsi (cells per square inch) and a wall thickness is 12 mil ( 1/1,000 inch), and the cell density of the carrier is 400 cpsi and the wall thickness is 3 mil.

Referring to FIG. 4 and FIG. 5, the nitrogen oxide reduction with the particulate filter is 5 to 15% lower than the nitrogen oxide reduction with the carrier, under the condition that the same amount of catalyst coating is used. Moreover, the greater the amount of catalyst coating on the particulate filter or carrier is, the larger the difference in nitrogen oxide reduction is. As the number of cells provided for the same volume increases, the contact area (contact time) between the walls and the exhaust gas increases. Accordingly, even with the same amount of catalyst coating, the flow-through carrier allows for a larger contact area (longer contact time) between the catalyst and the exhaust gas, compared to the wall-flow particulate filter, thereby improving the nitrogen oxide reduction. As mentioned previously, the first and the second supports 40 and 40′ in the present exemplary embodiment play the same roles as the flow-through carrier. Accordingly, the nitrogen oxide reduction can be improved by coating the first and the second catalysts 50 and 50′ on the first and the second supports 40 and 40′ rather than on the wall 30.

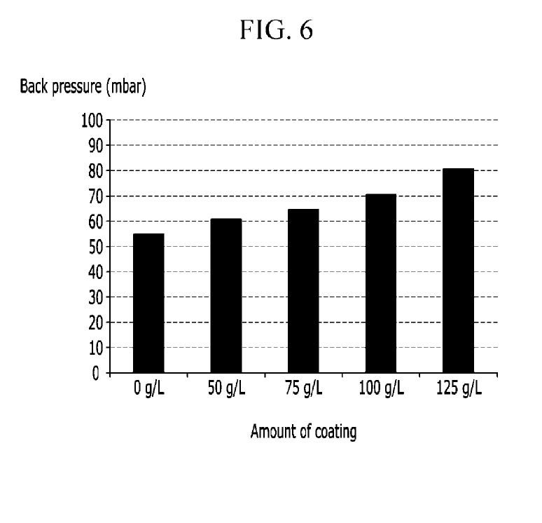

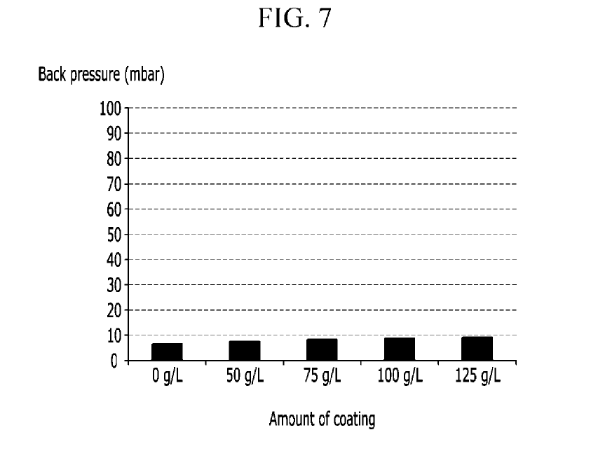

FIG. 6 is a graph illustrating the back pressure vs. the amount of catalyst coating in the wall-flow particulate filter; and FIG. 7 is a graph illustrating the back pressure vs. the amount of catalyst coating in the flow-through carrier.

FIG. 6 and FIG. 7 illustrate measurement data obtained by running the same engine in the same mode. The particulate filter used in the test has the same cross-sectional area, volume, and catalyst coating amount as the carrier used in the test. The cell density in the particulate filter used in the test is 300 cpsi (cells per square inch) and the wall thickness is 12 mil ( 1/1,000 inch), and the cell density in the carrier is 400 cpsi and the wall thickness is 3 mil.

Referring to FIG. 6 and FIG. 7, it can be seen that the back pressure applied to the particulate filter is five times higher than the back pressure applied to the carrier, under the condition that the same amount of catalyst coating is used. Also, it can be seen that the back pressure applied to the particulate filter increases greatly as the amount of catalyst coating on the particulate filter increases, whereas the back pressure applied to the carrier increases only slightly even if the amount of catalyst coating on the media increases. Accordingly, it is concluded that, in terms of back pressure, the flow-through carrier has more advantages over the wall-flow particulate filter as the amount of catalyst coating becomes increase. As mentioned previously, in this exemplary embodiment, the first and the second supports 40 play the same roles as the flow-through carrier. Therefore, coating the first and the second catalysts 50 and 50′ on the first and the second supports 40 and 40′ rather than on the wall 40 minimizes the increase in back pressure.

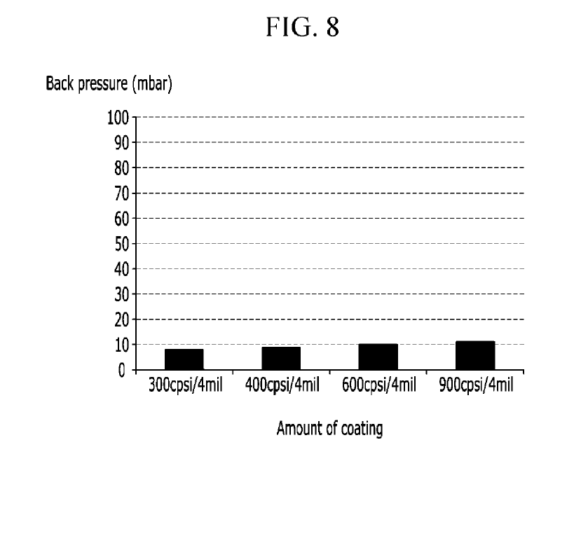

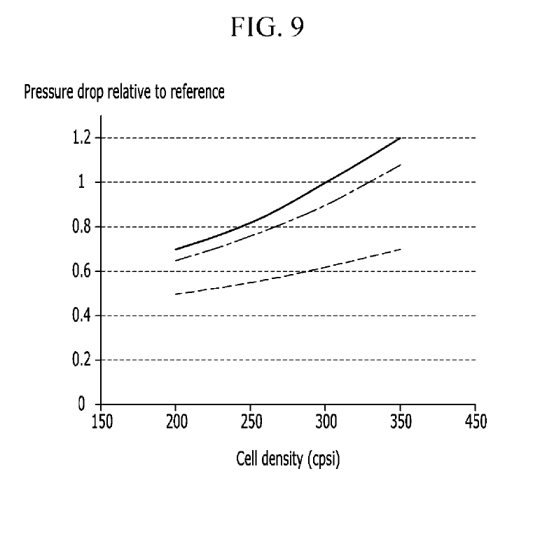

FIG. 8 is a graph illustrating the back pressure vs. the cell density in the flow-through carrier; and FIG. 9 is a graph illustrating the back pressure vs. the cell density in the wall-flow particulate filter.

The X-axis in FIG. 8 describes both the cell density and the wall thickness. For example, 300 cpsi/4 mil means a cell density is 300 cpsi and a wall thickness is 4 mil. FIG. 8 shows measurement data obtained only by varying the number of cells in flow-through carriers having the same cross-sectional area. Referring to FIG. 8, it can be seen that there is only a slight increase in back pressure even if the number of cells in the flow-through carrier increases. As mentioned previously, the first and the second supports 40 and 40′ in the present exemplary embodiment play the same roles as the flow-through carrier. Accordingly, it is expected that even an increase in the number of the first and the second supports 40 will result in only a slight increase in back pressure.

In FIG. 9, the dotted line represents a wall thickness of 8 mil, the one-dot chain line represents a wall thickness of 12 mil, and the solid line represents a wall thickness of 13 mil. FIG. 9 shows a ratio of the back pressure relative to a reference back pressure vs. cell density because the back pressure varies greatly with cell density. FIG. 9 shows measurement data obtained only by varying the number of cells in wall-flow particulate filters having the same cross-sectional area. Referring to FIG. 9, in the wall-flow particulate filter, the back pressure increases as the number of cells increases. It can be seen that the increase in back pressure is large especially if the wall thickness is large. Since the particulate filter functions as a filter, the larger the wall thickness is, the better the filter performance is. However, if the wall thickness is large, this limits the number of cells and causes a large increase in back pressure.

Referring overall to FIG. 4 through FIG. 9, the nitrogen oxide reduction rises as the amount of catalyst coating on the particulate filter 1 increases. However, the increase in the amount of catalyst coating on the particulate filter 1 causes a rise in back pressure. Moreover, the number of cells in the wall-flow particulate filter 1 is limited because of the back pressure and the thickness of the wall 30 (required to achieve sufficient filter performance).

On the other hand, in the case of the flow-through carrier, the increase in back pressure is small even with an increase in the amount of catalyst coating, and there is no need to achieve sufficient filter performance. Thus, the number of cells can be increased a lot by making the walls sufficiently thin. As mentioned previously, the first and the second supports 40 and 40′ according to the present exemplary embodiment are not required to function as filters but only serve as carriers for holding the first and the second catalysts 50 and 50′. Accordingly, the first and the second supports 40 and 40′ according to the present exemplary embodiment perform the same function as the flow-through carrier. Consequently, the increase in back pressure is minimized even with an increase in the number of the first and the second supports 40 and 40′. Moreover, a sufficient number of the first and the second supports 40 and 40′ can be mounted in the particulate filter 1 since the first and the second supports 40 and 40′ can be made thin. In addition, the first and the second supports 40 and 40′ allow for an increase in the amount of the first and the second catalysts 50 and 50′ supported on them and a longer contact time (larger contact area) between the first and the second catalysts 50 and 50′ and the exhaust gas, thereby improving the nitrogen oxide reduction.

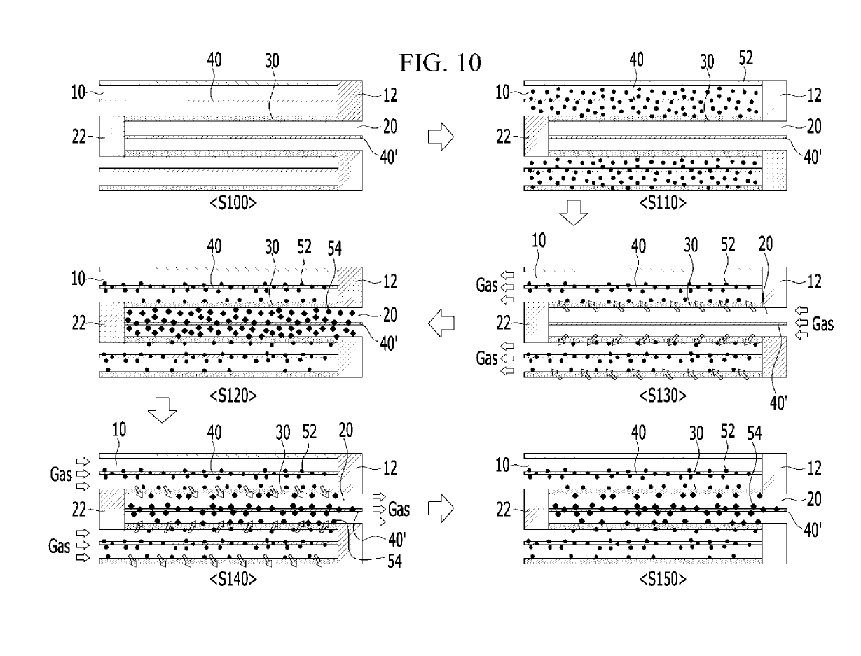

FIG. 10 is a schematic diagram sequentially illustrating a method of manufacturing a catalyzed particulate filter according to an exemplary embodiment of the present invention.

As shown in FIG. 10, the catalyzed particulate filter 1 is started to be manufactured by preparing a bare particulate filter at step S100. As described above, the bare particulate filter includes the at least one inlet channel 10, the at least one outlet channel 20, the at least one porous wall 30 defining the boundary between the adjacent inlet and outlet channels 10 and 20, the at least one first support 40 located within the at least one among the at least one inlet channel, and the at least one second support 40′ located within the at least one among the at least one outlet channel. After the bare particulate filter is manufactured through extrusion and so on, the both ends of the bare particulate filter are covered by the first and second plugs 12 and 22.

When the bare particulate filter is manufactured at the step S100, a first catalyst slurry 52 is injected into the at least one inlet channel 10 or the at least one outlet channel 20 at step S110. In the instant case, the at least one inlet channel 10 or the at least one outlet channel 20 is filled with the first catalyst slurry 52. For better comprehension and ease of description, it is exemplified in this specification that the first catalyst slurry 52 is injected into the inlet channels 10 and a second catalyst slurry 54 is injected into the outlet channels 20, but the present exemplary embodiment is not limited thereto. Therefore, the first catalyst slurry 52 is injected into the inlet channels 10 and neither of the first and the second catalyst slurries 52 and 54 is injected into the outlet channels 20 at the step S110.

Herein, making the first and the second catalyst slurries 52 and 54 will be briefly described.

Firstly, a catalyst solid particle having the same ingredients as a target catalyst is prepared. For example, if the target catalyst is an LNT catalyst, the catalyst solid particle including Al₂O₃, CeO₂, Ba, Pt, Pd, Rh, etc. is prepared. In addition, when the target catalyst is an SCR catalyst, the catalyst solid particle including zeolite, Cu, etc. is prepared. In addition, the first and the second catalyst solid particles are prepared according to types of the first and the second catalysts 50 and 50′.

After that, the catalyst solid particle is mixed with water so as to wet-grind the catalyst solid particle. At this time, content of the catalyst solid particle is approximately 20 wt %-40 wt %. Herein, the catalyst solid particle wet-grinded and mixed with the water is called the catalyst slurry.

In addition, pH of the catalyst slurry can be adjusted by adding acid component including acetic acid into the catalyst slurry, and a viscosity of the catalyst slurry can be changed by the pH of the catalyst slurry. That is, the viscosity of the catalyst slurry is controlled according to content of the solid particle, the pH of the catalyst slurry, and particle size of the solid particle. According to the present exemplary embodiment, the viscosities of the first and the second catalyst slurries 52 and 54 are controlled to be larger than or equal to 200 cpsi to prevent the first and the second catalyst slurries 52 and 54 from passing through the micropores on the porous walls 30.

In addition, amounts of the first and the second catalysts coated on the porous walls 30 are controlled according to average particle sizes of the first and the second catalyst solid particles. According to the present exemplary embodiment, the average particle sizes of the first and the second catalyst solid particles are so controlled that the first and the second catalyst slurries 52 and 54 cannot pass through the porous walls 30. That is, the average particle sizes of the first and the second catalyst solid particles are controlled to be larger than an average pore size of the porous walls 30.

After the step S110 is performed, gas is blown into the at least one outlet channel 20 or is drawn from the at least one inlet channel 10 so that a portion of the first catalyst slurry 52 is discharged from the at least one inlet channel 10 at step S120. For example, a blower is connected to the at least one outlet channel 20 and blows the gas into the at least one outlet channel 20. On the contrary, a vacuum pump is connected to the at least one inlet channel 10 and draws the gas from the at least one inlet channel 10. In addition, blowing the gas into the at least one outlet channel 20 and drawing the gas from the at least one inlet channel 10 may be simultaneously performed.

When the gas is blown into the outlet channels 20 or is drawn from the inlet channels 10 at a step S120, a pressure difference between the inlet channel 10 and the outlet channel 20 is generated. The gas passes through the outlet channel 20 and is then discharged from the inlet channel 10 by the pressure difference. At this time, the portion of the first catalyst slurry 52 filling the inlet channels 10 is discharged from the inlet channels 10 with the gas.

Since the pressure difference between the inlet channel 10 and the outlet channel 20 across the porous wall 30 is greatly generated, the gas passes through the porous wall 30 relatively quickly at the step S120. Therefore, a substantial amount of the first catalyst slurry 52 on the porous wall 30 forming the inside surface of the inlet channel 10 is removed from the porous wall 30 forming the inside surface of the inlet channel 10 and is discharged from the inlet channel 10.

As described above, since any one first support 40 is located within any one inlet channel 10, a pressure difference between two parts of the inlet channel 10 divided by the first support 40 is hardly generated. Therefore, the gas hardly passes through the first support 40 and moves along the first support 40 and the porous wall 30 forming the inside surface of the inlet channel 10. Therefore, a little amount of the first catalyst slurry 52 on the first support 40 is removed from the first support 40 and is discharged from the inlet channel 10.

When the gas is drawn from the inlet channel 10 filled with the first catalyst slurry 52 or is blown into the outlet channel 20, an amount of the first catalyst slurry 52 removed from the porous wall 30 forming the inside surface of the inlet channel 10 is larger than that of the first catalyst slurry 52 removed from the surface of the first support 40. Resultantly, the amount of the first catalyst 50 coated on the porous wall 30 forming the inside surface of the inlet channel 10 is small and the amount of the first catalyst 50 coated on the first support 40 is large. The increase in the back pressure when using the CPF may be suppressed by reducing the amount of the first catalyst 50 coated on the porous wall 30 forming the inside surface of the inlet channel 10, but the entire catalyst loading in the CPF may be increased by increasing the amount of the first catalyst 50 coated on the first support 40. The amount of the catalyst coated on the porous wall 30 can be controlled by adjusting a pressure of the gas which is blown into or drawn from the channel 10 or 20. When the pressure of the gas is high, the amount of the catalyst coated on the porous wall 30 decreases. When the pressure of the gas is low, on the contrary, the amount of the catalyst coated on the porous wall 30 increases. At this time, the amount of the catalyst coated on the support 40 or 40′ is hardly dependent upon the pressure of the gas which is blown into or drawn from the channel 10 or 20.

In addition, the amount of the catalyst coated on the porous walls 30 is dependent upon a viscosity of the catalyst slurry and an average particle size of the catalyst solid particle. Herein, the amount of the catalyst coated on the porous walls 30 refers to the amount of the catalyst remaining on the porous walls 30 after the gas is blown into or is drawn from the channel 10 or 20.

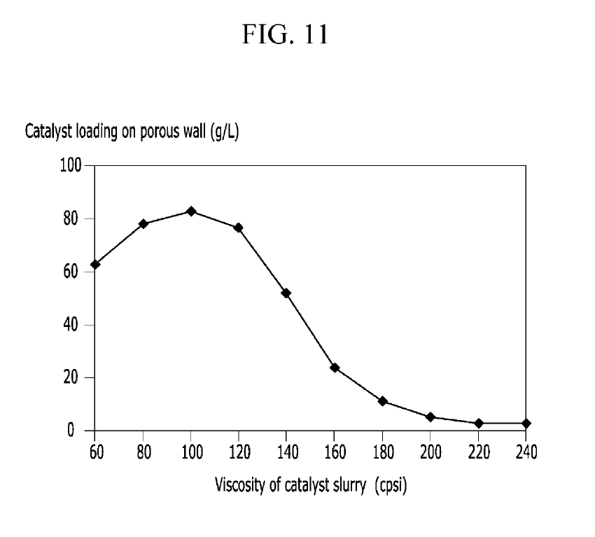

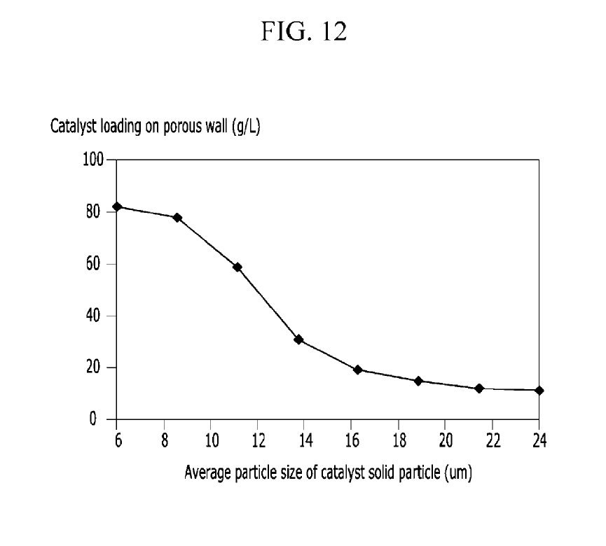

FIG. 11 is a graph showing a catalyst loading on porous walls according to a viscosity of a catalyst slurry; and FIG. 12 is a graph showing a catalyst loading on porous walls according to an average particle size of a solid particle of a catalyst slurry.

Graphs illustrated in FIG. 11 and FIG. 12 show results of experiments performed by using the porous wall 30, wherein the average pore size of the porous wall 30 is 12 um and porosity of the porous wall 30 is 55%.

As shown in FIG. 11, the amount of the catalyst coated on the porous walls 30 shows its maximum value when the viscosity of the catalyst slurry is approximately 100 cpsi, and quickly decreases as the viscosity of the catalyst slurry increases from approximately 100 cpsi. When the viscosity of the catalyst slurry is larger than or equal to 200 cpsi like the present exemplary embodiment, a little amount of the catalyst can be coated on the porous walls 30. As described above, if the amount of the catalyst coated on the porous walls 30 is small, increase in back pressure can be suppressed.

As shown in FIG. 12, the amount of the catalyst coated on the porous walls 30 decreases as the average particle size of the catalyst solid particle increases. For example, the amount of the catalyst coated on the porous walls 30 is less than or equal to 50 g/L when the average particle size of the catalyst solid particle is larger than or equal to 12 um, and the amount of the catalyst coated on the porous walls 30 is less than or equal to 20 g/L when the average particle size of the catalyst solid particle is larger than or equal to 18 um. As described above, when the amount of the catalyst coated on the porous walls 30 is small, increase in back pressure can be suppressed. Therefore, the amount of the catalyst coated on the porous walls 30 can be reduced by controlling the average particle size of the catalyst solid particle to be larger than the average pore size of the porous walls 30, suppressing increase in back pressure.

Resultantly, the viscosity of the catalyst slurry is set to be larger than or equal to 200 cpsi and the average particle size of the catalyst solid particle is set to be larger than the average pore size of the porous wall 30 to suppress increase in back pressure according to the exemplary embodiment of the present invention.

Referring to FIG. 10 again, when the portion of the first catalyst slurry 52 is discharged from the at least one inlet channel 10 at the step S120, the second catalyst slurry 54 is injected into at least one outlet channel 20 at step S130.

After performing the step S130, the gas is blown into the at least one inlet channel 10 or is drawn from the at least one outlet channel 20 so that a portion of the second catalyst slurry 54 is discharged from the at least one outlet channel 20 at step S140. For example, a blower is connected to the at least one inlet channel 10 and blows the gas into the at least one inlet channel 10. On the contrary, a vacuum pump is connected to the at least one outlet channel 20 and draws the gas from the at least one outlet channel 20. In addition, blowing the gas into the at least one inlet channel 10 and drawing the gas from the at least one outlet channel 20 may be simultaneously performed.

When the gas is blown into the inlet channels 10 or is drawn from the outlet channels 20 at the step S140, a pressure difference between the inlet channel 10 and the outlet channel 20 is generated. The gas passes through the inlet channel 10 and is then discharged from the outlet channel 20 by the pressure difference. At this time, the portion of the second catalyst slurry 54 filling the outlet channels 20 is discharged from the outlet channels 20 with the gas. In addition, a substantial amount of the second catalyst slurry 54 on the porous wall 30 forming the interior of the outlet channel 20 is removed from the porous wall 30 forming an interior of the outlet channel 20 and is discharged from the outlet channel 20. In addition, since any one second support 40′ is located within any one outlet channel 20, a pressure difference between two parts of the outlet channel 20 divided by the second support 40′ is hardly generated. Therefore, a little amount of the second catalyst slurry 54 on the second support 40′ is removed from the second support 40′ and is discharged from the outlet channel 20. Resultantly, the amount of the second catalyst 50′ coated on the porous wall 30 forming the inside surface of the outlet channel 20 is small and the amount of the second catalyst 50′ coated on the second support 40′ is large. The increase in the back pressure when using the CPF may be suppressed by reducing the amount of the second catalyst 50′ coated on the porous wall 30 forming the inside surface of the outlet channel 20, but the entire catalyst loading in the CPF may be increased by increasing the amount of the second catalyst 50′ coated on the second support 40′.

After that, the particulate filter from which the portion of the first catalyst slurry 52 and the portion of the second catalyst slurry 54 are discharged is dried/calcined at step S150 so that the catalyzed particulate filter 1 is manufactured.

When the CPF is manufactured through the manufacturing method according to the exemplary embodiment of the present invention, the first catalyst 50 coated on the porous wall 30 forming the inside surface of the inlet channel 10 and on the first support 40 and the second catalyst 50′ coated on the porous wall 30 forming the inside surface of the inlet channel 20 and on the second support 40′ may be different from each other, but are not limited thereto. That is, the first catalyst 50 and the second catalyst 50′ may be the same type.

In addition, the catalyst loading on the porous wall 30 serving as a filter is small so that the increase in the back pressure may be suppressed. Further, much of the catalyst can be coated on the first and the second supports 40 and 40′ which do not serve as filters and only support the catalyst. Therefore, performance of the catalyst may be improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of manufacturing a catalyzed particulate filter, comprising:
preparing a bare particulate filter including at least one inlet channel which has a first end being open and a second end being blocked, at least one outlet channel which has a first end being blocked and a second end being open and which is positioned alternately with the at least one inlet channel, at least one porous wall which defines a boundary between adjacent inlet and outlet channels, at least one first support which is located within at least one among the at least one inlet channel, and at least one second support which is located within at least one among the at least one outlet channel;
injecting a first catalyst slurry into the at least one inlet channel or the at least one outlet channel;
discharging a portion of the first catalyst slurry by blowing gas into the at least one outlet channel or the at least one inlet channel or drawing the gas from the at least one inlet channel or the at least one outlet channel;
injecting a second catalyst slurry into the at least one outlet channel or the at least one inlet channel;
discharging a portion of the second catalyst slurry by blowing gas into the at least one inlet channel or the at least one outlet channel or drawing the gas from the at least one outlet channel or the at least one inlet channel; and
drying/calcining the particulate filter from which the portion of the first catalyst slurry and the portion of the second catalyst slurry are discharged.

2. The method of claim 1, wherein the at least one inlet channel, the at least one outlet channel, the at least one porous wall, and the at least one first and second supports extend in a same direction.

3. The method of claim 1, wherein the first catalyst slurry is coated on an inside surface of the at least one inlet channel and the at least one first support or on an inside surface of the at least one outlet channel and the at least one second support, and the second catalyst slurry is coated on the inside surface of the at least one outlet channel and the at least one second support or the inside surface of the at least one inlet channel and the at least one first support.

4. The method of claim 2, wherein an amount of the first catalyst slurry removed from the inside surface of the at least one inlet channel or the at least one outlet channel is larger than amount of the first catalyst slurry removed from the first support or the second support in the discharging a portion of the first catalyst slurry.

5. The method of claim 2, wherein an amount of the second catalyst slurry removed from an inside surface of the at least one outlet channel or the at least one inlet channel is larger than amount of the second catalyst slurry removed from the second support or the first support in the discharging a portion of the second catalyst slurry.

6. The method of claim 2, wherein an amount of a catalyst coated on an inside surface of the inlet channels is controlled by adjusting a pressure of the gas which is blown into the outlet channels or which is drawn from the inlet channels.

7. The method of claim 2, wherein an amount of a catalyst coated on an inside surface of the outlet channels is controlled by adjusting a pressure of the gas which is blown into the inlet channels or which is drawn from the outlet channels.

8. The method of claim 1, wherein the first and the second supports include a same material as the porous walls.

9. The method of claim 1, wherein the first and the second support include a same material which is different from a material of the porous walls.

10. The method of claim 1, wherein viscosities of the first and the second catalyst slurries are larger than or equal to 200 cpsi.

11. The method of claim 10, wherein the viscosities of the first and the second catalyst slurries are controlled according to contents of solid particles of the first and the second catalyst slurries, pH of the first and the second catalyst slurries, and particle sizes of the solid particles of the first and the second catalyst slurries.

12. The method of claim 1, wherein average particle sizes of the first and the second catalyst solid particles of the first and the second catalyst slurries are controlled to be larger than an average pore size of the porous walls.

13. The method of claim 1, wherein the first catalyst slurry and the second catalyst slurry have same ingredients.

14. The method of claim 1, wherein the first catalyst slurry and the second catalyst slurry have different ingredients from each other.

15. The method of claim 14, wherein the first catalyst slurry is a lean NOx trap (LNT) catalyst slurry and the second catalyst slurry is a selective catalytic reduction (SCR) catalyst slurry.
